(19) United States
(12) Patent Application Publication
(10) Pub. No.: US 2020/0401495 A1
(43) Pub. Date: Dec. 24, 2020

(54) MESSAGE SELECTION FOR HARDWARE TRACING IN SYSTEM-ON-CHIP POST-SILICON DEBUGGING

(71) Applicants: International Business Machines Corporation, Armonk, NY (US); The Board of Trustees of the University of Illinois, Urbana, IL (US)

(72) Inventors: Flavio M De Paula, AUSTIN, TX (US); Debjit Pal, Urbana, IL (US); Shobha Vasudevan, Urbana, IL (US); Abhishek Sharma, Hillsboro, OR (US)

(21) Appl. No.: 16/448,091

(22) Filed: Jun. 21, 2019

(51) Int. Cl. G06F 11/34; G06F 9/54; G06F 17/50

(52) U.S. Cl. CPC G06F 11/348; G06F 17/5045; G06F 9/544; G06F 9/546

(57) ABSTRACT

Techniques message selection for hardware tracing in receiving system-on-chip (SoC) post-silicon debugging are described herein. An aspect includes receiving SoC design information corresponding to an SoC. Another aspect includes determining, based on the SoC design information, a set of messages that are exchanged between blocks of the SoC. Another aspect includes determining a set of possible combinations of messages of the set of messages. Another aspect includes determining a respective mutual information gain for each possible combination of messages in the set of possible combinations of messages. Another aspect includes selecting a combination of messages having a highest determined mutual information gain for monitoring via hardware tracing in the SoC.

### BACKGROUND

The present invention generally relates to system-on-chip (SoC) post-silicon debugging, and more specifically, to message selection for hardware tracing in SoC post-silicon debugging.

Post-silicon validation may be performed to debug and validate a system-on-chip (SoC) design. A relatively expensive component of post-silicon validation may include validation and debugging of application-level usage scenarios. In application-level usage scenario validation, a validator may exercise various usage scenarios of the SoC (e.g., for a smartphone, playing videos or surfing the Internet while receiving a phone call) and monitor the SoC for failures (e.g., hangs, crashes, deadlocks, overflows, etc.) during the usage scenario. Usage scenario validation may require a relatively large amount of validation time. Each usage scenario may include interleaved execution of multiple protocols among the intellectual property (IP) blocks that make up the SoC design. For example, a usage scenario that entails receiving a phone call in an SoC that is part of a smartphone while the phone is asleep may include protocols among an antenna, a power management unit, and a central processing unit (CPU) of the SoC.

### SUMMARY

According to an embodiment described herein, a system can include a processor to receive SoC design information corresponding to an SoC. The processor can also determine, based on the SoC design information, a set of messages that are exchanged between blocks of the SoC. The processor can also determine a set of possible combinations of messages of the set of messages. The processor can also determine a respective mutual information gain for each possible combination of messages in the set of possible combinations of messages. The processor can also select a combination of messages having a highest determined mutual information gain for monitoring via hardware tracing in the SoC.

According to another embodiment described herein, a method can include receiving SoC design information corresponding to an SoC. The method can also include determining, based on the SoC design information, a set of messages that are exchanged between blocks of the SoC. The method can also include determining a set of possible combinations of messages of the set of messages. The method can also include determining a respective mutual information gain for each possible combination of messages in the set of possible combinations of messages. The method can also include selecting a combination of messages having a highest determined mutual information gain for monitoring via hardware tracing in the SoC.

According to another embodiment described herein, a computer program product can include a computer readable storage medium having program instructions embodied therewith, the program instructions executable by a processing device to cause the processing device to perform a method including receiving SoC design information corresponding to an SoC. The method can also include determining, based on the SoC design information, a set of messages that are exchanged between blocks of the SoC. The method can also include determining a set of possible combinations of messages of the set of messages. The method can also include determining a respective mutual information gain for each possible combination of messages in the set of possible combinations of messages. The method can also include selecting a combination of messages having a highest determined mutual information gain for monitoring via hardware tracing in the SoC.

### BRIEF DESCRIPTION OF THE DRAWINGS

FIG. 1 is a block diagram of an example computer system for use in conjunction with one or more embodiments of message selection for hardware tracing in system-on-chip (SoC) post-silicon debugging;

FIG. 2 is a process flow diagram of a method for message selection for hardware tracing in SoC post-silicon debugging in accordance with one or more embodiments of the present invention; and

FIGS. 3A-3B are block diagrams of SoCs for use in conjunction with message selection for hardware tracing in SoC post-silicon debugging in accordance with one or more embodiments of the present invention.

### DETAILED DESCRIPTION

One or more embodiments of the present invention provide message selection for hardware tracing in system-on-chip (SoC) post-silicon debugging. To perform post-silicon validation, observation of messages that are exchanged between the IP blocks that make up the SoC may be required. Messages between IP blocks in an SoC may be monitored using hardware tracing, in which a relatively small set of signals corresponding to messages within the SoC are monitored continuously during SoC operation. However, the effectiveness of hardware tracing may be limited by the particular messages that are selected for monitoring; not all messages in the SoC may be monitored due to hardware constraints (e.g., a size of a trace buffer). Omission of a particular message (e.g., a critical interface register) from the set of monitored messages may manifest relatively late in the validation process, e.g., during post-silicon debug, at which point it may be too late to perform a corrected silicon spin of the SoC design to allow monitoring of a particular message. Therefore, message selection for hardware tracing may be performed based on a determination of a mutual information gain for various possible message combinations in the SoC, and selecting a message combination having a highest determined mutual information gain for monitoring by the hardware tracing.

The IP blocks of an SoC, including but not limited to one or more processors, antennas, power management units, network interfaces, universal serial bus (USB) interfaces, memory controller units, and/or input/output (I/O) units, may be interconnected in any appropriate fashion. Messages are exchanged between IP blocks via the plurality of connections; a physical connection between IP blocks in the SoC may correspond to a particular respective message. A subset of the messages in the SoC may be selected for hardware tracing based on SoC design information that describes sequences of transactions among the SoC IP blocks. The SoC design information may include a flow-based specification of a particular usage scenario of the SoC, and a mapping of the flow-based specification to the hardware implementation of the SoC.

Based on the SoC hardware design information, a set of all possible message combinations may be determined, and a hardware constraint, such as the size of a trace buffer, may be applied to the set of all possible message combinations. Mutual information gain may be determined for each possible message combination that meets the hardware constraint (e.g., any message combinations that are smaller than a width of the trace buffer). In some embodiments, a flow-specification coverage may be determined for each possible message combination that fits the hardware constraint. The set of possible message combinations may then be ranked based on the determined respective mutual information gain, and the combination of messages corresponding to the highest determined mutual information gain may be selected for monitoring. If the selected message combination and the hardware constraint allow (e.g., the selected message combination does not completely fill the width of the trace buffer), additional messages may be added to the selected messages in order to increase hardware tracing coverage. Each selected message may correspond to a particular IP block I/O in the SoC. The SoC design may be updated to include trace connections to the selected messages, and the SoC may be fabricated such that the selected messages can be monitored by hardware tracing in the physical SoC.

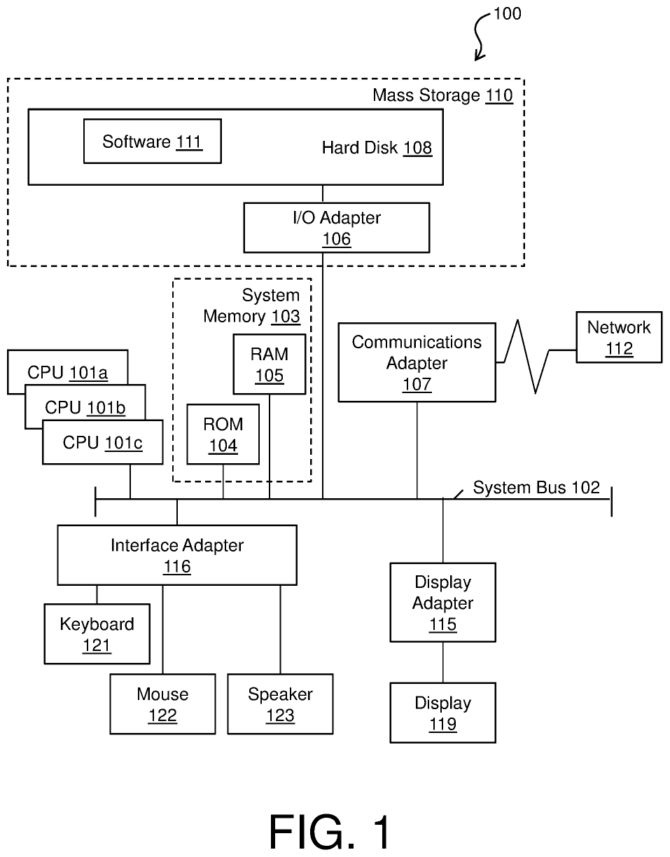

Turning now to FIG. 1, a computer system 100 is generally shown in accordance with an embodiment. The computer system 100 can be an electronic, computer framework comprising and/or employing any number and combination of computing devices and networks utilizing various communication technologies, as described herein. The computer system 100 can be easily scalable, extensible, and modular, with the ability to change to different services or reconfigure some features independently of others. The computer system 100 may be, for example, a server, desktop computer, laptop computer, tablet computer, or smartphone. In some examples, computer system 100 may be a cloud computing node. Computer system 100 may be described in the general context of computer system executable instructions, such as program modules, being executed by a computer system. Generally, program modules may include routines, programs, objects, components, logic, data structures, and so on that perform particular tasks or implement particular abstract data types. Computer system 100 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, the computer system 100 has one or more central processing units, i.e., CPUs 101a, 101b, 101c, etc. (collectively or generically referred to as processor 101). The processors 101 can be a single-core processor, multi-core processor, computing cluster, or any number of other configurations. The processors 101, also referred to as processing circuits, are coupled via a system bus 102 to a system memory 103 and various other components. The system memory 103 can include a read only memory (ROM) 104 and a random access memory (RAM) 105. The ROM 104 is coupled to the system bus 102 and may include a basic input/output system (BIOS), which controls certain basic functions of the computer system 100. The RAM is read-write memory coupled to the system bus 102 for use by the processors 101. The system memory 103 provides temporary memory space for operations of said instructions during operation. The system memory 103 can include random access memory (RAM), read only memory, flash memory, or any other suitable memory systems.

The computer system 100 comprises an input/output (I/O) adapter 106 and a communications adapter 107 coupled to the system bus 102. The I/O adapter 106 may be a small computer system interface (SCSI) adapter that communicates with a hard disk 108 and/or any other similar component. The I/O adapter 106 and the hard disk 108 are collectively referred to herein as a mass storage 110.

Software 111 for execution on the computer system 100 may be stored in the mass storage 110. The mass storage 110 is an example of a tangible storage medium readable by the processors 101, where the software 111 is stored as instructions for execution by the processors 101 to cause the computer system 100 to operate, such as is described herein below with respect to the various Figures. Examples of computer program product and the execution of such instruction is discussed herein in more detail. The communications adapter 107 interconnects the system bus 102 with a network 112, which may be an outside network, enabling the computer system 100 to communicate with other such systems. In one embodiment, a portion of the system memory 103 and the mass storage 110 collectively store an operating system, which may be any appropriate operating system, such as the z/OS or AIX operating system from IBM Corporation, to coordinate the functions of the various components shown in FIG. 1.

Additional input/output devices are shown as connected to the system bus 102 via a display adapter 115 and an interface adapter 116 and. In one embodiment, the adapters 106, 107, 115, and 116 may be connected to one or more I/O buses that are connected to the system bus 102 via an intermediate bus bridge (not shown). A display 119 (e.g., a screen or a display monitor) is connected to the system bus 102 by a display adapter 115, which may include a graphics controller to improve the performance of graphics intensive applications and a video controller. A keyboard 121, a mouse 122, a speaker 123, etc. can be interconnected to the system bus 102 via the interface adapter 116, which may include, for example, a Super I/O chip integrating multiple device adapters into a single integrated circuit. Suitable I/O buses for connecting peripheral devices such as hard disk controllers, network adapters, and graphics adapters typically include common protocols, such as the Peripheral Component Interconnect (PCI). Thus, as configured in FIG. 1, the computer system 100 includes processing capability in the form of the processors 101, and, storage capability including the system memory 103 and the mass storage 110, input means such as the keyboard 121 and the mouse 122, and output capability including the speaker 123 and the display 119.

In some embodiments, the communications adapter 107 can transmit data using any suitable interface or protocol, such as the internet small computer system interface, among others. The network 112 may be a cellular network, a radio network, a wide area network (WAN), a local area network (LAN), or the Internet, among others. An external computing device may connect to the computer system 100 through the network 112. In some examples, an external computing device may be an external webserver or a cloud computing node.

It is to be understood that the block diagram of FIG. 1 is not intended to indicate that the computer system 100 is to include all of the components shown in FIG. 1. Rather, the computer system 100 can include any appropriate fewer or additional components not illustrated in FIG. 1 (e.g., additional memory components, embedded controllers, modules, additional network interfaces, etc.). Further, the embodiments described herein with respect to computer system 100 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

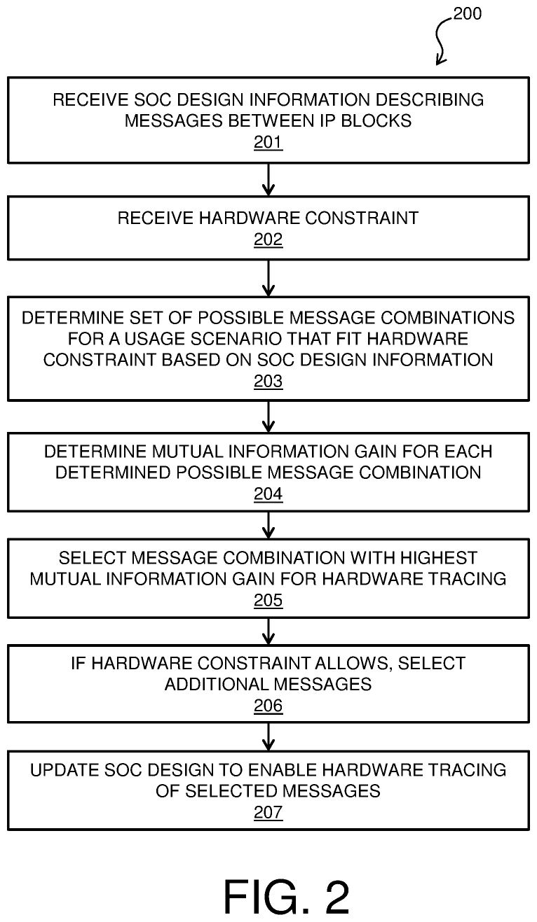

FIG. 2 is a process flow diagram of a method 200 for message selection for hardware tracing in SoC post-silicon debugging in accordance with one or more embodiments of the present invention. Method 200 may be implemented in conjunction with any appropriate computer system, such as computer system 100 of FIG. 1. A computer application may be configured to perform message selection for hardware tracing in SoC post-silicon debugging according to method 200 of FIG. 2 in some embodiments; such a computer application may be part of software 111 as shown in FIG. 1. In block 201, SoC design information is received. An SoC design includes a plurality of IP blocks, including but not limited to one or more processors, antennas, power management units, network interfaces, universal serial bus (USB) interfaces, memory controller units, and/or input/output (I/O) units, that are interconnected in any appropriate fashion. The SoC design information may include any appropriate description of interactions between the IP blocks, such as timing diagrams and/or operations flow charts. The SoC design information may include a flow-based specification of one or more usage scenarios of the SoC, and a mapping of the flow-based specification to the hardware implementation of the SoC. In block 202, a hardware constraint of the SoC is received. The hardware constraint may include a width of a trace buffer of the SoC.

In block 203, a set of all messages that are exchanged for a flow corresponding to a particular usage scenario of the SoC are determined based on the SoC design information that was received in block 201, and a set of possible message combinations that fit the hardware constraint is determined based on the hardware constraint of block 202. The number of all possible message combinations may be given by

$${\sum }_{k = 1}^{n} ( \begin{matrix}n \\ k\end{matrix} )$$

in some embodiments, where n is the number of messages in the set of all messages that are exchanged for the particular usage scenario. It is then determined whether any of the possible message combinations do not fit the hardware constraint. For example, if the hardware constraint is a width of the trace buffer, only message combinations including a number of bits that are less than or equal to the width of the trace buffer may be included in the set of possible message combinations that fit the hardware constraint in block 203.

In some embodiments, a flow may be a directed acyclic graph (DAG) defined as a tuple, e.g., F= [symbol] S,S₀,Sₚ, ε, δ_{F}, Atom [symbol] , where S is the set of flow states, S₀⊆S is the set of initial states, Sₚ⊆S and Sₚ∩Atom=Ø is called the set of stop states, ε is a set of messages, δ_{F}⊆S×ε×S is the transition relation and Atom⊂S is the set of atomic states of the flow. An indexed message may be a pair α= [symbol] m, i [symbol] where m is the message and iϵ [symbol] , referred to as the index of α. An indexed state may be a pair ŝ= [symbol] s, j [symbol] where s is a flow state and jϵ [symbol] , referred as the index of ŝ. An indexed flow [symbol] f, k [symbol] may be a flow consisting of indexed message m and indexed state ŝ indexed by kϵ [symbol] . Any two indexed flows [symbol] F, i [symbol] , [symbol] G, j [symbol] may be said to be legally indexed either if F≠G or, if F=G, then if i≠j. A usage scenario may be a pattern of frequently used applications in the SoC. Each such pattern may include multiple interleaved flows corresponding to messaging between hardware IPs in the SoC. For example, F and G may be two legally indexed flows. The interleaving F [symbol] G is a flow called an interleaved flow that is defined as U=F [symbol] G= [symbol] F·S×G·S, F·S₀×G·S₀, F·Sₚ×G·Sₚ, F·ε∪G·ε, δ_{U}, F·Atom∪G·Atom [symbol] where δ_{U} is defined as:

$$\frac{{s}_{1} {\to }^{α} {s}_{1}^{′} ⋀ {s}_{2} ∉ G . Atom}{〈 {s}_{1} , {s}_{2} 〉 {\to }^{α} 〈 {s}_{1}^{′} , {s}_{2} 〉} and \frac{{s}_{2} {\to }^{β} {s}_{2}^{′} ⋀ {s}_{1} ∉ F . Atom}{〈 {s}_{1} , {s}_{2} 〉 {\to }^{β} 〈 {s}_{1} , {s}_{2}^{′} 〉} , \qquad ( EQ . 1 )$$

where s₁, s′₁ϵF·S, s₂, s′₂ϵG·S, αϵF·ε, βϵG·ε. Every path in the interleaved flow may be an execution of U, and represents an interleaving of the messages of the participating flows.

In block 204, a mutual information gain is determined for each possible message combination that fits the hardware constraint that was determined in block 203. The mutual information gain may be determined in any appropriate manner in various embodiments. The mutual information gain may be used evaluate the quality of a selected combination of messages with respect to the interleaving of a set of flows in the SoC design. In some embodiments, two random variables may be associated with an interleaved flow, namely X and Yᵢ. X may represent the different states in the interleaved flow, i.e., X may take any value in the set S of the different states of the interleaved flow. M=Uᵢ εᵢ may be the set of all possible indexed messages in the interleaved flow. Y′ᵢ may be a candidate message combination, and Yᵢ may be a random variable representing all indexed messages corresponding to Y′ᵢ. All values of X may be equally probable since the interleaved flow can be in any state, hence p_{X}(x)=1/|S|. To determine a marginal distribution of Yᵢ, the number of occurrences of each indexed message in the set M′ over the entire interleaved flow may be counted. Therefore p_{Yi}(y)=(the number of occurrences of y in the flow)/(the number of occurrences of all indexed messages in the flow). To find the joint probability, the conditional probability and the marginal distribution may be determined, i.e., p(x,y)=p(x|y)p(y)=p(y|x)p(x). P(x|y) may be calculated as a fraction of the interleaved flow states in which x is reached after the message Yᵢ=y has been observed. In other words, p(x|y) may be the fraction of times x is reached, from the total number of occurrences of the indexed message y in the interleaved flow, i.e., p_{X|Yi}(x|y)=(the number occurrence of y in the flow leading to x)/(total number occurrences of y in the flow). Substituting these values in I(X;Y) gives a mutual information gain of the state set X with respect to Yᵢ.

In block 205, the possible message combination corresponding to the highest mutual information gain that was determined in block 204 is selected for hardware tracing. In block 206, the selected message combination may be compared to the hardware constraint, and, if the hardware constraint allows, one or more additional message combinations may be added to the selected message combination. For example, if the selected message combination does not completely fill the width of the trace buffer, additional messages may be added to the selected messages until the trace buffer is full. In order to maximize trace buffer utilization, one or more smaller message groups may be packed into the trace buffer. In some embodiments, these smaller message groups may be part of a larger message that cannot be fit into the trace buffer, e.g. in OpenSPARCT2, dmu_sii_data is 20 bits wide message, whereas cpu_thread_id, which is a subgroup of dmu_sii_data, is 6 bits wide. A smaller message group may be selected such that the information gain of the selected message combination in union with this smaller message group is maximized. Additional smaller message groups may be added to the selected messages until the trace buffer is full.

In block 207, the design of the SoC may be updated to include trace connections between the trace buffer and the connections corresponding to the selected messages. The SoC may then be fabricated according to the updated design to include the trace connections, and the selected messages may be monitored by hardware tracing via the trace connections during validation and debugging of the physical SoC.

The process flow diagram of FIG. 2 is not intended to indicate that the operations of the method 200 are to be executed in any particular order, or that all of the operations of the method 200 are to be included in every case. Additionally, the method 200 can include any suitable number of additional operations.

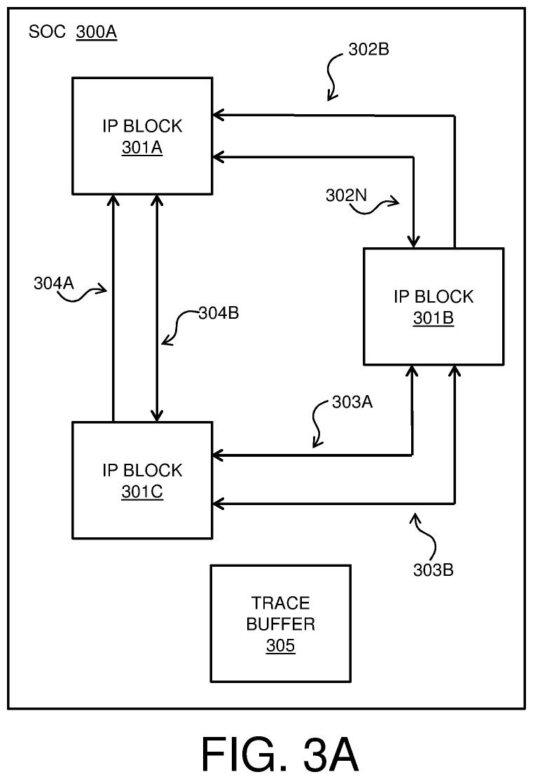

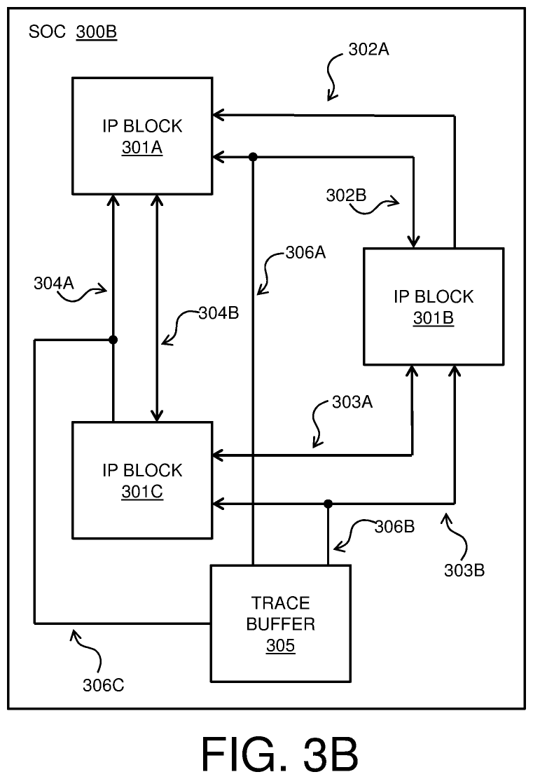

FIGS. 3A-B are block diagrams of an SoC 300A-B for use in conjunction with message selection for hardware tracing in SoC post-silicon debugging in accordance with one or more embodiments of the present invention. SoC 300A-B of FIGS. 3A-B illustrates some embodiments of method 200 of FIG. 2. SoC 300A of FIG. 3A includes a plurality of IP blocks, including IP block 301A, IP block 301B, and IP block 301C. The IP blocks 301A-C may each be any appropriate type of IP block, including but not limited to one or more processors, antennas, power management units, network interfaces, USB interfaces, memory controller units, and/or I/O units. An SoC such as SoC 300A may include any appropriate number and types of IP blocks such as IP blocks 301A-C. The IP blocks 301A-C are interconnected, as illustrated by connections 302A-B between IP block 301A and IP block 301B; connections 303A-B between IP block 301B and IP block 301C; and connections 304A-B between IP block 301C and IP block 301A. There may be any appropriate number of connections between any two IP blocks in an SoC such as SoC 300A. Embodiments of method 200 of FIG. 2 are not restricted to the network topology described by SoC 300A-B of FIG. 3.

During operation of the SoC 300A, the IP blocks 301A-C exchange messages via the connections 302A-B, connections 303A-B, and connections 304A-B. Each connection of connections 302A-B, connections 303A-B, and connections 304A-B may correspond to a respective message in some embodiments. Each message may have any appropriate purpose. The SoC design information that is received in block 201 of method 200 of FIG. 2 may describe an exchange of messages between IP blocks 301A-C via connections 302A-B, connections 303A-B, and connections 304A-B during a particular usage scenario of the SoC 300A. In an example embodiment of block 201 of method 200 of FIG. 2, a usage scenario may include message 1 (m1) corresponding to connection 303A, message 2 (m2) corresponding to connection 302B, message 3 (m3) corresponding to connection 303B, and message 4 (m4) corresponding to connection 304A. Each of messages m1, m2, m3, and m4 may have a different respective size (i.e., number of bits).

Trace buffer 305 in FIG. 3A is a memory element that is embedded in the SoC 300A. The trace buffer 305 may have a defined width and depth. In some embodiments, the hardware constraint that is received in block 202 of method 200 of FIG. 2 may be a width of the trace buffer 305, as the width of the trace buffer 305 may limit a number of messages that can be monitored by hardware tracing in the SoC 300A. During validation of the SoC 300A, the trace buffer 305 may store messages that are passed via a selected subset of connections for hardware tracing, and the information in trace buffer 305 may be used to debug the SoC 300A. In order to monitor a particular message by hardware tracing, the trace buffer 305 must be physically connected to the connection that transports the message by a trace connection. Example trace connections 306A-C are shown in SoC 300B in FIG. 3B.

Embodiments of method 200 of FIG. 2 may be used to determine the placement of trace connections such as trace connections 306A-C in SoC 300B. In an example embodiment of method 200 of FIG. 2, the set of all possible message combinations that fit the hardware constraint, as determined in block 203 of FIG. 2, may be determined to include all combinations of messages m1, m2, m3, and m4 that fit the width of trace buffer 305. In this example embodiment, it may be determined that there are 15 possible combinations for the 4 messages corresponding to the usage scenario,

$$e . g . , {\sum }_{k = 1}^{4} ( \begin{matrix}4 \\ k\end{matrix} ) .$$

Of these 15 possible combinations, two combinations, for example, m2, m3) and (m1, m2, m3, and m4) may not fit the width of trace buffer 305. Therefore, in block 204 of method 200 of FIG. 2, the mutual information gain is not determined for those two combinations that do not fit the width of the trace buffer 305; a mutual information gain is determined for each of the remaining 13 combinations. In block 205, the message combination having the highest mutual information gain that was determined in block 204 may be selected for monitoring via hardware tracing. In an example embodiment, the selected message combination may include m2, m3, and m4. Therefore, in block 207, the design of the SoC 300A may be updated as shown in SoC 300B of FIG. 3B, with respective trace connections 306A-C between trace buffer 305 and connections 302B, 303B, and 304A. The SoC 300B may then be fabricated to include the trace connections 306A-C between trace buffer 305 and connections 302B, 303B, and 304A, and the messages that are transported via connections 302B, 303B, and 304A may be monitored during validation of SoC 300B using trace buffer 305.

In some embodiments, one or more additional trace connections may be added to SoC 300B based on block 206 of method 200 of FIG. 2. For example, a trace connection may be added to connection 304B if the message transported by connection 304B will fit in any remaining space in the width of the trace buffer 305.

It is to be understood that the block diagram of FIG. 3 is not intended to indicate that the SoC 300A-B is to include all of the components shown in FIG. 3. Rather, the SoC 300A-B can include any appropriate fewer or additional components not illustrated in FIG. 3 (e.g., additional memory components, embedded controllers, IP blocks, connections between IP blocks, trace connections, modules, inputs, outputs, etc.). Further, the embodiments described herein with respect to SoC 300A-B may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A system comprising a processor configured to:
receive system-on-chip (SoC) design information corresponding to an SoC;
determine, based on the SoC design information, a set of messages that are exchanged between blocks of the SoC;
determine a set of possible combinations of messages of the set of messages;
determine a respective mutual information gain for each possible combination of messages in the set of possible combinations of messages; and
select a combination of messages having a highest determined mutual information gain for monitoring via hardware tracing in the SoC.

2. The system of claim 1, wherein the SoC design information comprises a flow-based specification corresponding to a usage scenario of the SoC and a mapping of the flow-based specification to a hardware implementation of the SoC.

3. The system of claim 2, wherein the set of messages correspond to the usage scenario.

4. The system of claim 1, the processor configured to:
receive a hardware constraint; and
apply the hardware constraint to the set of possible combinations of messages, wherein the mutual information gain is not determined for any possible combination of messages that does not fit the hardware constraint.

5. The system of claim 4, wherein the hardware constraint comprises a width of a trace buffer of the SoC.

6. The system of claim 4, the processor configured to:
based on the hardware constraint, add one or more additional messages to the selected combination of messages for monitoring via hardware tracing in the SoC.

7. The system of claim 1, the processor configured to:
update the SoC design information to include a respective trace connection corresponding to each message in the selected combination of messages.

8. A computer-implemented method, comprising:
receiving, by a processor, system-on-chip (SoC) design information corresponding to an SoC;
determining, based on the SoC design information, a set of messages that are exchanged between blocks of the SoC;
determining a set of possible combinations of messages of the set of messages;
determining a respective mutual information gain for each possible combination of messages in the set of possible combinations of messages; and
selecting a combination of messages having a highest determined mutual information gain for monitoring via hardware tracing in the SoC.

9. The computer-implemented method of claim 8, wherein the SoC design information comprises a flow-based specification corresponding to a usage scenario of the SoC and a mapping of the flow-based specification to a hardware implementation of the SoC.

10. The computer-implemented method of claim 9, wherein the set of messages correspond to the usage scenario.

11. The computer-implemented method of claim 8, comprising:
receiving a hardware constraint; and
applying the hardware constraint to the set of possible combinations of messages, wherein the mutual information gain is not determined for any possible combination of messages that does not fit the hardware constraint.

12. The computer-implemented method of claim 11, wherein the hardware constraint comprises a width of a trace buffer of the SoC.

13. The computer-implemented method of claim 11, comprising:
based on the hardware constraint, add one or more additional messages to the selected combination of messages for monitoring via hardware tracing in the SoC.

14. The computer-implemented method of claim 8, comprising:
update the SoC design information to include a respective trace connection corresponding to each message in the selected combination of messages.

15. A computer program product comprising:
a computer readable storage medium having program instructions embodied therewith, the program instructions executable by a processing device to cause the processing device to perform a method comprising:
receiving system-on-chip (SoC) design information corresponding to an SoC;
determining, based on the SoC design information, a set of messages that are exchanged between blocks of the SoC;
determining a set of possible combinations of messages of the set of messages;
determining a respective mutual information gain for each possible combination of messages in the set of possible combinations of messages; and
selecting a combination of messages having a highest determined mutual information gain for monitoring via hardware tracing in the SoC.

16. The computer program product of claim 15, wherein the SoC design information comprises a flow-based specification corresponding to a usage scenario of the SoC and a mapping of the flow-based specification to a hardware implementation of the SoC.

17. The computer program product of claim 16, wherein the set of messages correspond to the usage scenario.

18. The computer program product of claim 15, the method comprising:
receiving a hardware constraint; and
applying the hardware constraint to the set of possible combinations of messages, wherein the mutual information gain is not determined for any possible combination of messages that does not fit the hardware constraint.

19. The computer program product of claim 18, wherein the hardware constraint comprises a width of a trace buffer of the SoC.

20. The computer program product of claim 18, the method comprising:
based on the hardware constraint, add one or more additional messages to the selected combination of messages for monitoring via hardware tracing in the SoC.
